(19) United States
(12) Patent Application Publication
(10) Pub. No.: US 2003/0177263 A1
(43) Pub. Date: Sep. 18, 2003

(54) Routing in a communications network

(76) Inventor: Gerald A Robinson, Redditch (GB)

Correspondence Address: NIXON & VANDERHYE, PC, 1100 N GLEBE ROAD, 8TH FLOOR, ARLINGTON, VA, 22201-4714, US

(21) Appl. No.: 10/380,541

(22) PCT Filed: Sep. 28, 2001
(86) PCT No.: PCT/GB01/04340

(30) Foreign Application Priority Data
Sep. 29, 2000 (EP) 00308628.7

(51) Int. Cl. G06F 15/173

(52) U.S. Cl. 709/239; 709/240

(57) ABSTRACT

A routing algorithm having particular advantage in sparsely connected networks in which nodes have a primary and a secondary route to a destination node, these routes being node-disjoint. Setup messages have an additional information element for the identity of a virtual source node, and a source node inserts its own identity in the virtual source information element. Unless a node is the destination for a message, it examines the content of the virtual source information element of a message, and if there is no match with its own identity it selects a route pointer from a part of its routing table in the form of a matrix of pointer bits, and uses that pointer to select one of the primary and secondary routes for the destination node. If that route is unavailable, the node replaces the content of the virtual source information element with its own identity, inverts the pointer bit to select the other route. If neither route is available, the node replaces the content of the virtual source information element with the identity of the node from which it was received, and sends the message back to the node from which it was received.

This invention relates to a method of routing in a communications network of interconnected nodes, and particularly, but not exclusively, to a method of routing in a sparsely connected network.

A number of routing algorithms are known for routing in a network of interconnected nodes. For example, in the event of a fault preventing a message from being forwarded from a transit node to an adjacent node, the message is sent on an alternative route to that adjacent node via another transit node. In another example, known as source node routing, if there is a fault on a primary route to a destination node, the message is returned to the source node and a secondary route is tried from the source node to the destination node.

U.S. Pat. No. 5,649,108 (Spiegel et al.), issued Jul. 15, 1997, discloses a routing algorithm in which a source node, having a routing table containing, for each destination node, first choice, second choice, etc. complete end-to-end routes, i.e. each such route being a list of those nodes that a connection setup packet should pass through to establish a connection, selects one of first and second routing mode flags and selects from its routing table the first choice route to a destination node in response to a connection request. The source node generates a connection setup packet having a source route field, a record route field (for containing a list of those nodes through which the connection has already been established), a cumulative cost field, a cost threshold field, a crankback limit field, and a routing mode flag field. The source node copies the first choice end-to-end route from its routing table into the source route field, and establishes a connection to a first intermediate node located along the first choice route by sending the connection setup packet to that first intermediate node.

The first intermediate node is responsive to the first routing mode flag for extending the connection along the first choice route, i.e. testing the link to the next node of the first choice route as defined by the source route field and sending the packet to that next node if the link is available, and for updating the record route and cumulative cost fields.

If that link is not available, operation of the intermediate node is determined by which of the routing mode flags has been set. If the second routing mode flag has been set for that setup packet, i.e. requiring source node routing, then the first intermediate node sends a NACK to the source node. Upon receipt of the NACK, the source node releases that connection and generates a new setup packet, copying the stored end-to-end second choice route into the source route field of that new setup packet. However, if the second routing mode flag has been set for that setup packet, then that intermediate node records that link as being blocked for this connection, and attempts to find a new path tail from itself to the destination node by determining whether there is another path available in its routing table. which has not been tested before. If there is, a path is selected and tested by adding the cost to the cumulative cost and comparing the new cumulative cost with the cost threshold. If the new cumulative cost is too high, control loops back to selecting from that routing table another path from among the possible paths to the destination node. If the new cumulative cost is not too high, the new path is checked to see whether it includes any links recorded as being blocked for this connection, and, if so, control loops back again to select another new path. If the new path does not include any blocked links, a check is made to see whether the new path causes any loops, and if so whether a crankback to the previous node would exceed the value in the crankback limit field. If the crankback limit would be exceeded, control loops back again to select another new path, but if not, then the crankback limit field is decremented from its initial value of one, and the setup packet cranked back to the previous node. On receipt of a cranked back setup packet, a node decrements the cumulative cost field in respect of the link from the cranking back node, removes that node's identifier from the record route field, and proceeds to find a new path tail from itself to the destination node.

In the event that an intermediate node fails to extend the connection along the first choice route, it will try to find a new path tail by repeatedly selecting and testing one of its respective set of first choice, second choice, etc. paths to the destination node until either a suitable path is found or all the paths have been tested.

Thus it can be seen that in Spiegel et al. the routing table in each node has to contain, for each respective destination node, a set of complete end-to end routes for copying into the source route fields of the setup packets. Conventionally, for such a routing algorithm there would be in the region of six to eight alternative routes for each destination node.

The article “Steady-State Performance of an Adaptive Sequential Routing Algorithm” by Harold M Heggestad, Proceedings of the National Telecommunications Conference (NTC '81), New Orleans, La., U.S.A., Nov. 29 to Dec. 3, 1981, discloses a spill-forward routing algorithm and a sequential routing algorithm. In the spill-forward routing algorithm, each node has a routing table containing for each destination node a list of the links leaving that node ranked in order of their link blocking probabilities, and has a three-fold call attempt process, namely (1) a link leaving a source node is tried if and only if all links above it in the routing table are blocked, (2) when an intermediate node is reached, control is passed (“spills forward”) to it as if it had become the source node, and (3) when a call request is blocked at all exits from a node, it is dropped and re-initiated by the originator. In the sequential routing algorithm, which is a modification of the spill-forward routing algorithm, each node has a routing table similar to that for the spill-forward routing algorithm, and has a three-fold call attempt process, namely (1) a link leaving a source node is tried if and only if all links above it in the routing table are blocked, (2) a call request which is blocked at all exits from an intermediate node is cranked back to the closest preceding node having any still-untried links, and (3) a call request is ultimately blocked if and only if every possible source node/destination node route is blocked. When a node sends a call request packet to a neighbouring node, it extends a route history in the call request header by adding a field containing its own identity, the neighbouring node identity and an indication of whether the packet is being forwarded or returned.

Thus it can be seen that in Heggestad each node always acts in source mode and will only crankback a packet when all exits have been tried and found to be blocked.

In accordance with one aspect of the present invention, there is provided a method of routing a message in a communications network of interconnected nodes, the nodes being arranged to generate messages, each message having a destination information element containing the identity of a destination node for that message, a source information element containing the identity of the source node of that message, and a virtual source information element initially containing the identity of that source node, and each of the nodes having a respective routing table containing respective entries corresponding to source node/destination node pairs, each entry being in the form of a ranked pair of alternative next hop routes, the method comprising performing at a said node the steps of:

(a) comparing its own node identity with the destination node identity of a message to be routed; and, when it is not the destination node for that message,

(b) comparing its own node identity with the virtual source node identity of that message, and,

if there is a match at step (b),

(c) operating in source mode, else,

(d) operating in transit mode;

wherein step (c) comprises the substeps of

(e) accessing its routing table in accordance with the virtual source node/destination node pair of that message to find the corresponding entry,

(f) forwarding the message to the higher ranking next hop route of that corresponding entry if that higher ranking next hop route has not been tried for that message, and in the event that that higher ranking next hop route is unavailable or has already been tried for that message,

(g) forwarding the message to the next hop route of that corresponding entry not yet tried, and in the event that step (g) fails,

(h) replacing the content of the virtual source information element of the message with the node identity of the node from which that message was received, and

(i) sending that message back to that node from which it was received;

and wherein step (d) comprises the substeps of

(j) retrieving, in accordance with the virtual source node/destination node pair of that message, a pointer from a matrix of pointers forming part of that routing table,

(k) selecting one of the ranked pair of alternative next hop routes of that corresponding entry in accordance with that retrieved pointer,

(l) forwarding the message to the selected next hop route, and in the event that step (I) fails,

(m) replacing the content of the virtual source information element of the message with its own node identity and performing step (c) from substep (g) onwards.

Preferably, substep (f) comprises the further substep (n) of checking a handled messages store of the said node to see whether the handled messages store already contains an entry for that message and making a new entry for that message in the handled messages store if it does not already contain such an entry, and

substep (l) comprises the further substep (o) of making a new entry for that message in a handled messages store of the said node.

More preferably substep (n) comprises the further substep (p) of storing in a next hop identifier field of that new entry made by the substep (n) an identifier for that higher ranking next hop route for that message, and

substep (o) comprises the further substep (q) of storing in a next hop identifier field of that new entry made by the substep (o) the pointer retrieved from the matrix.

Preferably, when substep (n) finds that the handled messages store already contains an entry for that message, substep (g) comprises the further substep (r) of using the content of the next hop identifier field of the entry for that message for selecting the said as yet untried next hop route for that message.

Preferably, the said pointers are single bit pointers.

More preferably, when substep (g) is performed subsequently to substep (m), step (g) comprises the further substep (s) of accessing the stored retrieved pointer of the entry for that message and using bit inversion for selecting the said as yet untried next hop route for that message.

Preferably, substep (g) comprises the further substep (r) of using the content of the next hop identifier field of the entry for that message for selecting the said as yet untried next hop route for that message.

In accordance with another aspect of the present invention, there is provided a node for use in a communications network of interconnected nodes, the node being arranged to generate messages, each message having a destination information element containing the identity of a destination node for that message, a source information element containing the identity of the source node of that message, and a virtual source information element initially containing the identity of that source node, and having a routing table for containing respective entries corresponding to source node/destination node pairs of the network, each entry being in the form of a ranked pair of alternative next hop routes, and being arranged:

to compare its own node identity with the destination node identity of a message to be routed; and, when it is not the destination node for that message,

to compare its own node identity with the virtual source node identity of that message, and,

to operate in source mode in the event of a match between its own node identity and the virtual source node identity by

accessing its routing table in accordance with the virtual source node/destination node pair of that message to find the corresponding entry,

forwarding the message to the higher ranking next hop route of that corresponding entry if that higher ranking next hop route has not been tried for that message, and in the event that that higher ranking next hop route is unavailable or has already been tried for that message,

forwarding the message to the next hop route of that corresponding entry not yet tried, and in the event that the not yet tried next hop route is not available,

replacing the content of the virtual source information element of the message with the node identity of the node from which that message was received, and

sending that message back to that node from which it was received; and

to operate in transit mode in the event of a mismatch between its own node identity and the virtual source node identity by

retrieving, in accordance with the virtual source node/destination node pair of that message, a pointer from a matrix of pointers forming part of that routing table,

selecting one of the ranked pair of alternative next hop routes of that corresponding entry in accordance with that retrieved pointer,

forwarding the message to the selected next hop route, and in the event that the selected next hop route is not available,

replacing the content of the virtual source information element of the message with its own node identity and switching to operate in source mode by

forwarding the message to the next hop route of that corresponding entry not yet tried, and in the event that the not yet tried next hop route is not available,

replacing the content of the virtual source information element of the message with the node identity of the node from which that message was received, and

sending that message back to that node from which it was received.

Preferably the node is further arranged to check a handled messages store of the said node to see whether the handled messages store already contains an entry for that message and to make a new entry for that message in the handled messages store if it does not already contain such an entry.

More preferably, the node is further arranged to store in a next hop identifier field of that new entry for that message an identifier for that higher ranking next hop route for that message, if it is operating in source mode and has generated that message, and otherwise, if it is operating in transit mode and has received that message, to store in a next hop identifier field of that new entry the pointer retrieved from the matrix.

More preferably still, the node is further arranged, in the event that the check of the handled messages store finds that the handled messages store already contains an entry for that message, to use the content of the next hop identifier field of the entry for that message for selecting the said as yet untried next hop route for that message.

Yet more preferably, said next hop route identifier and said pointer are both in the form of a single bit.

The node may be further arranged, when handling a message for which there is already an entry in the handled messages store, to access the next hop identifier field of that entry and to use bit inversion for selecting the said as yet untried next hop route for that message.

Preferably, the node is further arranged, when handling a message for which there is already an entry in the handled messages store, to change the state of a crankback flag of that entry from reset to set when forwarding the message, and, if that crankback flag is already in its set state, to replace the content of the virtual source information element of that message with the node identity of the node from which that message was received, and to send that message back to that node from which it was received.

In accordance with a further aspect of the present invention, there is provided a communications network of interconnected nodes, each of the nodes being as defined in any of the preceding paragraphs relating to nodes.

Specific embodiments of a method in accordance with the present invention will now be described by way of example with reference to the drawings, in which:

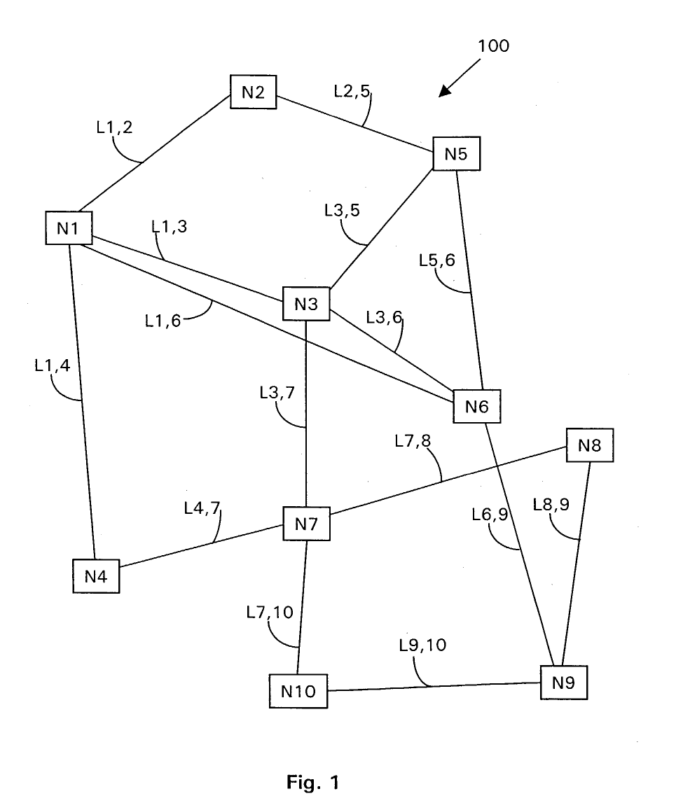

FIG. 1 shows a sparsely connected network;

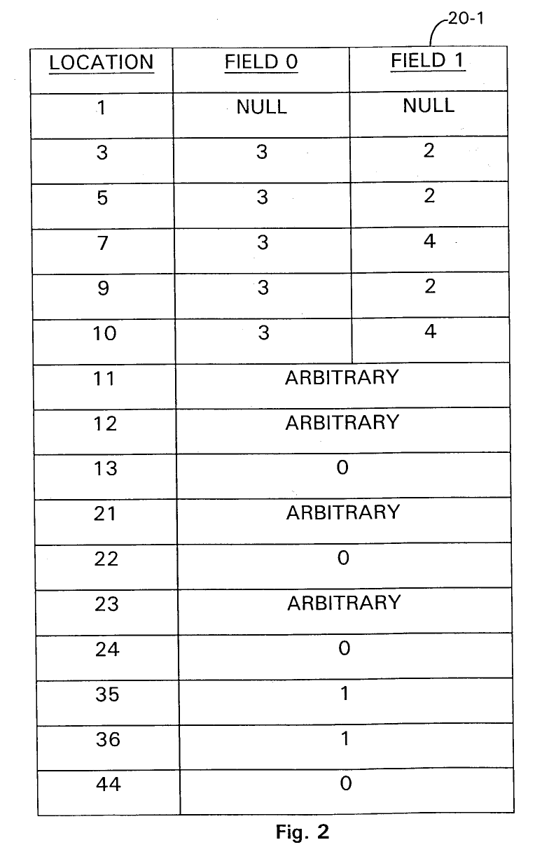

FIG. 2 shows a routing table for one of the nodes of FIG. 1; and

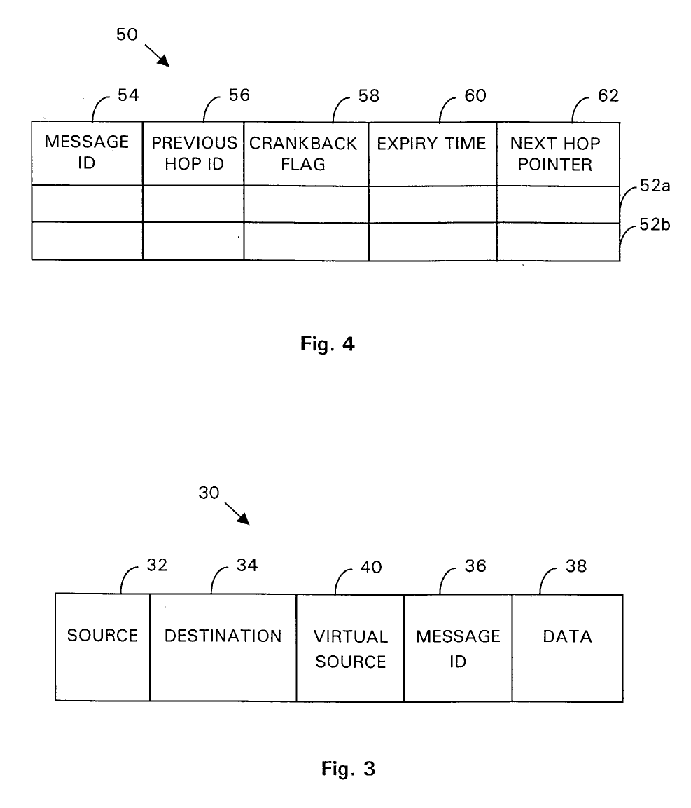

FIG. 3 shows the structure of a message generated by the nodes of FIG. 1;

FIG. 4 shows the structure of a received messages store of the nodes of FIG. 1;

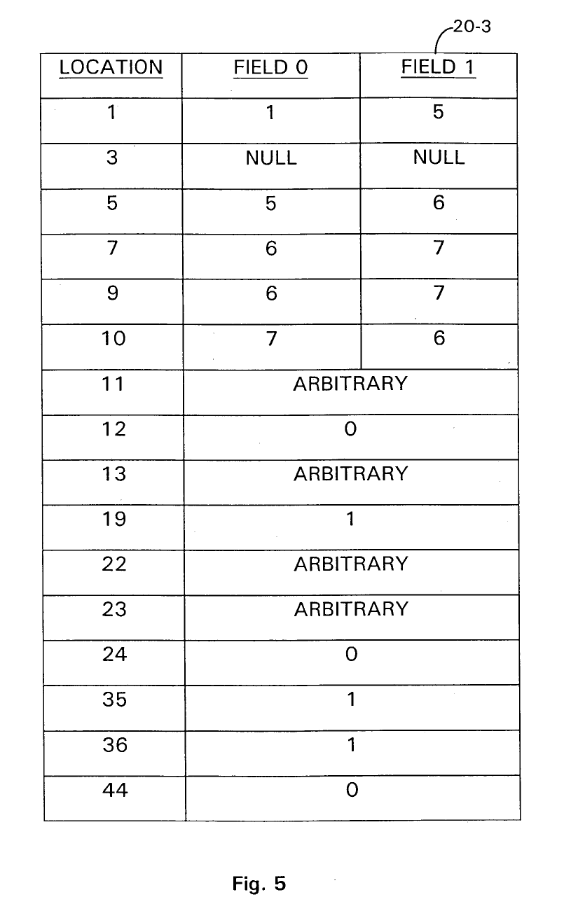

FIGS. 5 to 7, respectively show routing tables for three other of the nodes of FIG. 1; and

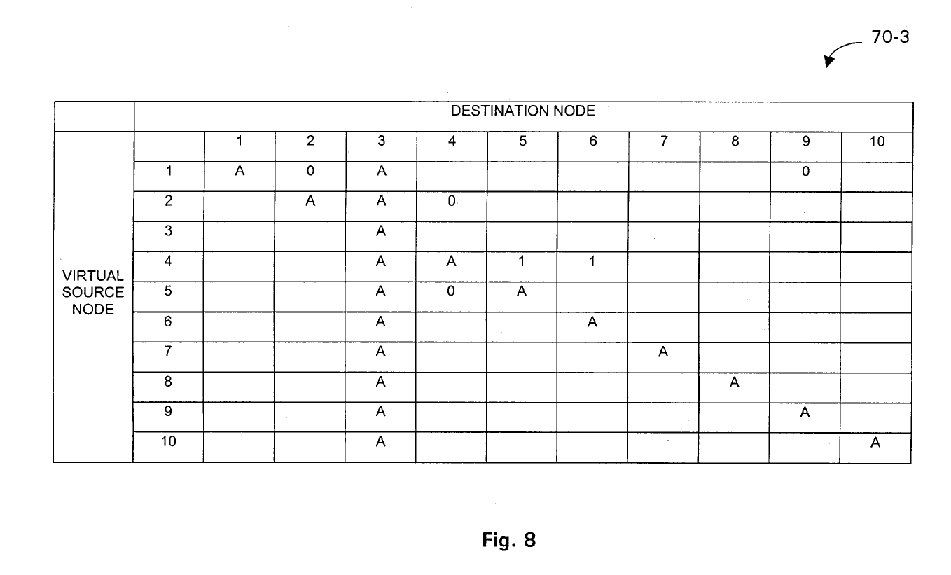

FIG. 8 shows a pointer matrix forming part of the routing tables of the nodes of FIG. 1.

Before proceeding to the detailed description, the reader may find it useful to have definitions of some of the terms in this art; and the reader should note that herein the terms “message” and “packet” have the same meaning and are used interchangeably.

In general, crankback refers to a mechanism for re-routing circuits which have either been broken due to the failure of some network element, or else have been unable to be established along their designated routes because of a change in network conditions since the “topology state database” from which the routes were computed was last updated.

One particular form of crankback, “Crankback to Source”, also referred to as source routing, is when a call, i.e. a call Setup Request message, arrives at a node, also referred to as a switch, but it cannot be forwarded to the next node, i.e. the next hop node designated either in a designated transit list (DTL) of the message, if a DTL call setup technique is used in the network, or else in a routing table, also known as a route indicator, stored in the node, and a message is sent to the originating node of the DTL or the call, requiring the call to be re-routed on a separate route. Crankback to Source is used in asynchronous transfer mode (ATM) networks when a call has been broken due to the failure of some network element.

Hop by hop crankback is when a call arrives at a node at which it becomes “stalled” because it cannot be forwarded to the next stage on its route, i.e. the next hop node, and a message is sent to the previous node on the route requiring that previous node to re-route the call in such a way as to avoid the node where it had become stalled.

Limited loop prevention is where, if a node attempts to route a call Setup Request message back to the node from which it has just received that call Setup Request message, i.e. attempts to perform a “u-turn”, then this condition will be recognised and the switch will be prevented from sending the request to that node.

In FIG. 1, a network 100 comprises a multiplicity of switching nodes NX, where X is a numerical node identifier, also referred to as a node ID, and interconnecting links LX,Y, where X and Y are terminating node identifiers for that link. As an example, the link interconnecting nodes N1 and N2 is arbitrarily designated L1,2, although it could equally be designated L2,1. Herein, node NX will be described as having the node identity “X”.

The nodes NX are arranged to switch traffic being carried in accordance with international standards for ATM, and although, for convenience, only ten nodes, N1 to N10, are shown, in a practical network there will be many more nodes, e.g. in the planned UK ATM network there will be about a hundred nodes. The present invention is not limited to ATM networks, thus in variants the nodes can be arranged for switching traffic being carried in accordance with other standards, e.g. plesiochronous digital hierarchy or synchronous digital hierarchy using CCITT No 7 signalling system, and can be packet switching nodes for use in data networks. With the convergence of telecommunications and computing, it will be appreciated that such a data network can carry data between computer terminals connected to the data network, or can carry communications traffic between communications terminals, e.g. telephones, connected to the data network.

The network 100 is partially meshed, in other words, not every node NX is connected to every other node NX. If the network were fully meshed, also known as a fully connected, or fully interconnected network, there would be n(n−1)/2 links LX,Y where n is the total number of nodes in the network, but in situations where the present invention is particularly advantageous, the network 100 has considerably fewer links LX,Y, and such a network is referred to as a sparsely connected network. Typically, a sparsely connected network has fewer than half the number of links LX,Y of a fully meshed network,.

Each of the nodes NX of network 100 has a respective routing table 20-X (e.g. routing table 20-1 shown in FIG. 2) stored in memory, also referred to as a database, for use in routing messages. For messages for which it is the actual or the virtual source, a node NX stores for each destination node, i.e. each other of the nodes, a respective pair of ranked routes to respective next hop nodes, i.e. a respective primary route and a secondary route. These routes are also referred to as pre-planned routes. As described in more detail below, the primary, i.e. higher ranking, route is to be tried first for calls for which the node is the actual source or the virtual source, and, when the primary route is not available, e.g. because of a link failure or a node failure, the lower ranking route is tried.

In this embodiment, the routes of each respective pair are node-disjoint routes, in other words, other than the source and destination nodes, they do not have any other node in common. However, in some sparsely connected networks it may not be possible or desirable for the routes of a pair to be node-disjoint routes, but the present invention will still work advantageously.

When a node NX responds to locally-generated network signalling from a calling party for the establishment of a new connection from itself to a destination node NX serving the called party, it will act as a source node, also referred to as acting in source mode, and will generate a Setup Request message 30, also known as a Routing Request, shown in FIG. 3, comprising a plurality of information elements, also known as and referred to hereafter as fields, namely, a source node identity field 32, destination node identity field 34, a message identifier (ID) field 36, and a data field 38, these fields being known in the art, and an additional field 40, which will be referred to as the virtual source node identity field. When a node generates the Setup Request message 30, it will insert its own identity in the source node identity field 32 and also in the virtual source node identity field 40. For convenience, hereafter field 32 will be referred to as source field, field 34 will be referred to as destination field, field 36 will be referred to as ID field, and field 40 will be referred to as virtual source field.

Referring to FIG. 2, which shows a portion of the routing table 20-1 of node N1, a routing table 20-X, for a node NX of the ten node network 100 of FIG. 1, comprises a first part extending from storage location #1 to storage location #10 for use when node NX is acting in source mode, and a second part extending from storage location #11 to storage location #100 for use when node NX is acting in transit mode. This second part comprises nine sections, the first section extending from storage location #11 to storage location #20, the second section extending from #21 to #30, and so on.

Thus, in each node NX the first part always corresponds to that node acting in source mode, i.e. when a node determines that there is a match between its node identity and the virtual source node identity retrieved from a setup request message that it is handling. Furthermore, in node N1, the nine sections correspond to virtual source nodes N2 to N10, respectively; in node N2, the nine sections correspond to virtual source nodes N1, and N3 to N10, respectively; in node N3, the nine sections correspond to virtual source nodes N1, N2 and N4 to N10, respectively; and so on. So, in general, for a network of n nodes, the correspondence of the sections of the second part of the routing tables to the virtual source of a received message is in accordance with the following accessing algorithm:

for the ith node, the first (i−1) sections correspond respectively to messages having as virtual sources, nodes N1 to N(i−1), and the remaining sections, i.e. n−(i−1) sections, correspond respectively to messages having as virtual sources, nodes N(i+1) to Nn.

Each storage location of the first part comprises a first field, having a field identifier 0 (Field 0), for storing a primary next hop identifier and a second field, having a field identifier 1 (Field 1), for storing a secondary next hop identifier. The next hop identifiers, also referred to as next hop route identifiers, are in this embodiment next hop node identifiers, i.e. numerical node identifiers, and the fields need be only a single byte for networks having fewer than 255 nodes. In variants, the next hop identifiers are identifiers of the links or routes to those next hop nodes.

Each storage location of the second part comprises just a single field for storing a single bit field pointer, conveniently 0 for pointing to the Field 0 for use as the outgoing transit route, and 1 for pointing to the Field 1 for use as the outgoing transit route, but in variants the pointer value 1 is used to point to the Field 0, and correspondingly 0 is used to point to the Field 1.

Each of the nodes NX of network 100 also has a respective received messages store 50 (shown in FIG. 4) stored in memory, wherein each record 52 comprises a message ID field 54, a previous hop node ID field 56, a crankback flag field 58, an expiry time field 60, and a next hop pointer field 62. In FIG. 4 only two 10 records 52a, 52b are shown, but in practice the received messages store 50 will have capacity for hundreds of records. It will be appreciated that a new record 52 will always have a “0” in its crankback flag field 58. As will be described for a specific example later, a node changes this value from “0” to “1” when it first receives a cranked back message, i.e. one which it has already forwarded. It will also be appreciated that a node will create a new record in its received messages store 50 when it acts as a source node and generates a new Setup Request message 30, and for such a new record it will enter the field identifier 0 in the next hop pointer field 62. Thus, for the purpose of the present invention, the received messages store 50 will also be referred to as a handled messages store.

Each node stores a predetermined value for the maximum allowed time for setting up a connection, this value having been established by the network administration for the network 100. Upon the creation of a new record 52, a node generates a value for the expiry time field 60 by adding that predetermined value to the current time of the node's internal clock. The respective clocks are maintained synchronised with each other in a known manner, but the manner in which this is effected is not relevant to the present invention and will not be described.

Each node includes a manager (not shown) for its received messages store 50, which periodically checks the records 52 and deletes any record having an expiry time value less than the node's current time. This provides that old records are automatically purged from the received messages store 50. It will be appreciated that any other suitable method for purging the received messages store 50 of old messages can be used.

When a node handles a generated or received Setup Request message 30, or in fact any message, it retrieves the content of the destination field 34, the content of the virtual source field 40, and the content of the message ID field 36 and firstly checks whether it has handled that message before by accessing its received messages store 50 in accordance with the retrieved message ID. If there is no record 52 having a matching message ID in its field 54, it checks whether it is the destination node for that message by comparing its own node identity with the retrieved destination node identity. In variants, the node retrieves the content of the destination field 34 and the content of the virtual source field 40 only after it has ascertained that has not received that message before.

Having determined that it is not the destination node, it will add a record 52 to its received messages store 50, and then proceed by comparing its own identity with the retrieved virtual source node identity. If the comparison result is a match, then the node will act in source mode, but if the comparison result is a mismatch, then the node will act in transit mode. Once the node has determined the relevant mode, it refers to its routing table 20-X on the basis of the retrieved destination node and virtual source node identities, as will be described later.

Referring again to FIG. 2, in the routing table 20-1 of source node N1 the first part comprises locations #1 to #10, but only locations #1, #3, #5, #7, #9 and #10 are shown. The content of the fields of the first location #1 are a null node identity because node N1 cannot be its own destination node. In variants, the location corresponding to the associated node is omitted, resulting in, for a network of n nodes, only (n−1) locations each having two node identity fields, and a similar accessing algorithm can be used, e.g. for the ith node, location #1 corresponds to destination node N1, location #2 corresponds to destination node N2, and so on up to location #(i−1), then location #i corresponds to destination node N(i+1), and so on up to location #(n−1) which corresponds to destination node Nn. An alternative way of expressing this algorithm is that location #m corresponds to destination node Nm for m<i, and corresponds to destination node N(m+1) for m>i.

In the second part of the routing table 20-1, there are shown only locations #11, #1 2 and #13 of the first section, locations #21, #22, #23 and #24 of the second section, locations #35 and #36 of the third section, and location #44 of the fourth section. The first section (#11 to #20) is for use when a received Setup Request message 30 has node N2 as its virtual source. The locations #13 to #20 respectively correspond to messages having destination nodes N3 to N10. The location #11 corresponds to a message terminating at node N1, and therefore contains an arbitrary entry because the node will not proceed beyond recognising that it is the destination for that message. The location #12 corresponds to a message having node N2 as its destination, and will similarly contain an arbitrary entry because no such messages will exist.

For the particular topology of the network 100, the pointer value of the field of location #13 of the routing table 20-1 is 0, which means that when node N1 receives a Setup Request message 30 having, say, N2 as its virtual source node, and N3 as its destination node, node N1's message handling will produce the knowledge that:

(a) the node N1 is not the destination for that message;

(b) there is no match between the identity of the node N1 (“1”) and that of the virtual source (“2”), and therefore the node N1 will act in transit mode; and

(c) in transit mode the node N1 will access the first section of the second part of the routing table 20-1 (i.e. corresponding to messages having N2 as virtual source node), third entry (location #13), to retrieve a pointer value indicative of which of the two next node routes (Field 0, or Field 1 ) of the source mode routes to the destination node N3 it is to forward that message.

Since the pointer value retrieved from the field of location #13 is “0”, the Setup Request message 30 will be forwarded on the Field 0 route of the third location #3 of the first part of the routing table 20-1, i.e. the location corresponding to the destination node N3. The content of this Field 0 is “3”, so node N1 will send the Setup Request message 30 to the node N3, and will store the pointer value “0” in the next hop pointer field 62 of the new entry that it makes in its received messages store 50 in respect of the received Setup Request message 30.

The routing table 20-3 of node N3, shown in FIG. 5, will now be briefly described. In the routing table 20-3 there are shown only locations #1, #3, #5, #7, #9 and #10 of the first part, and in the second part, only locations #11, #12, #13 and #19 of the first section, locations #22, #23 and #24 of the second section, locations #35 and #36 of the third section, and location #44 of the fourth section. As will now be understood, the first section (#11 to #20) of this “transit mode” part of the routing table is for use when a received Setup Request message 30 has node N1 as its virtual source. The locations #12, and #14 to #20 respectively correspond to messages having destination nodes N2, and N4 to N10. The location #11 corresponds to a message having node N1 as its destination, and will contain an arbitrary entry because no such messages will exist. The location #13 corresponds to a message terminating at node N3, and therefore similarly contains an arbitrary entry because the node will not proceed beyond recognising that it is the destination for that message.

Consider now a specific example of a new call at (source) node N1 for (destination) node N9. The primary route from node N1 to node N9 is via link L1,3 to node N3, link L3,7 to node N7, link L7,8 to node N8, and finally link L8,9 to node N9 and the secondary route is via link L1,2 to node N2, link L2,5 to node N5, link L5,6 to node N6, and finally link L6,9 to node N9.

The source node N1 will generate a Setup Request message 30 having its fields 32, 34 and 40 containing 1, 9, 1, respectively (hereafter referred to as S/D/VS=1/9/1), and its message identity field 36 containing a unique message ID, and apply a common handling procedure to the Setup Request message 30. This common handling procedure comprises first retrieving the message ID from field 40 and checking the message ID field 54 of records 52 in its received messages store 50 in respect of that retrieved message ID to see whether that particular message had been received before, and, if not, as will be the case for a newly generated Setup Request message 30, it will create a new record 52 corresponding to that newly generated Setup Request message 30 in its received messages store 50-1. This new record 52 will contain the retrieved message ID in its message field 54, null content in its previous hop node identity field 56 because this message was not received from a neighbouring node, an appropriate value for the expiry time in its field 60, and, as the node N1 has generated this message, the value “0” in its next hop pointer field 62. When using a null content as above, it is convenient for the node identities to exclude the null value.

In variants, a source node omits checking the message ID field 54 and creates the new record as soon as it is in possession of the unique message ID for the newly generated Setup Request message 30.

It will be appreciated that in the context of the present invention the corresponding record 52 in question will be the record having a message ID in its field 54 matching that of the Setup Request message 30 being handled by the node.

The source node N1 will also retrieve the identity of the destination node from the destination field 34 of the newly generated Setup Request message 30 and check to see whether the destination node identity matches its node identity, i.e. whether it is to perform message capture for an associated terminal or whether it is to send the message on to another node in the network. It will be appreciated that for a newly generated Setup Request message 30 this check is not needed, and in variants it is omitted when the node handles a newly generated Setup Request message 30.

The source node N1 will also retrieve the identity of the virtual source node from the virtual source field 40 and compare that identity with its own identity to see whether it is to act in source mode or in transit mode. In the case of a newly generated Setup Request message 30, there is a match between the virtual source node identity and that generating node's own identity, so, in this case, the node N1 will access the first, “source”, part of its routing table 20-1, FIG. 2, in accordance with the identity of the destination node. For this specific example, the particular location #9 will be accessed, and the value in Field 0 (i.e. “3”) retrieved. The source node N1 will now send this newly generated Setup Request message 30 to its neighbouring node N3.

Upon receipt at the node N3 of the Setup Request message 30 (S/D/VS=1/9/1) from node N1, the node N3 will retrieve the message ID from field 40 and check its received messages store (50-3, but not shown separately) in respect of the retrieved message ID to see whether that particular message had been received before. As this is the first receipt of this message the result of this check will be negative and in this event the node N3 will create a corresponding new record 52 (FIG. 4) for that message in its received messages store 50-3. This new record will have the value “1” in its previous hop node identity field 56, and the value “0” in its crankback flag field 58.

Having created this new record 52, the node N3 will now, in usual manner, retrieve the identity of the destination node, “9”, from the destination field 34 of the received Setup Request message 30 and check to see whether the destination node identity matches its own node identity “3”, i.e. whether node N3 is to capture the message for an associated terminal or whether it is to send the message on to another node in the network.

As the node N3 is not the destination node for that message, it will then, if it has not already done so, retrieve the identity of the virtual source node from the virtual source field 40 and compare that identity with its own identity to see whether it is to act in source mode or in transit mode. In this case, there is a mismatch between the virtual source node identity “1” and its own identity “3”, so it will access the second, “transit”, part of its routing table 20-3, FIG. 5, in accordance with the above algorithm, i.e. for virtual source node identity “1” the relevant section is the first section, and for destination node identity “9” the relevant location is #19. This location #19 contains the pointer value “1”, thus indicating that Field 1 of location #9, i.e. for destination node N9, is to be accessed to obtain the identity, “7”, of the next hop node to which that Setup Request message 30 is to be forwarded. In this case, it will be appreciated that the primary route from node N3 to node N9 is not part of the primary route from node N1 to node N9.

Node N3 now writes the pointer value “1” retrieved from location #19 into the next hop pointer field 62 of its new record 52, and forwards the Setup Request message 30 to node N7.

To avoid any possible confusion because of the use in this embodiment of a number of nodes which has the same value as the radix of the numbering system of the storage locations, it should be understood that when node N3 handles a message having, for example, S/D/VS=1/10/1, it will access the first section of the transit part of its routing table, and the tenth location within that first section, namely #20. And as a further example, if network 100 were to have fifteen additional nodes making a total of twenty five nodes, then the location in the first section of the second, transit, part corresponding to this message (S/D/VS=1/10/1) would be #35.

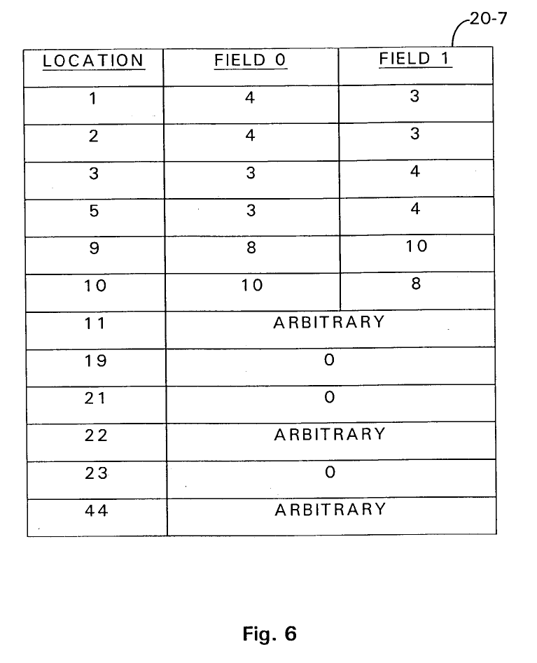

Upon receipt of that Setup Request message 30 (S/D/VS=1/9/1), node N7 will similarly check its received messages store, and make a new record 52 in its received messages store (50-7, but not shown separately). For this message from node N3, the newly stored record 52 will have “3” in its previous hop node identity field 56, and “0” in its crankback flag field 58. Having created this new record 52, node N7 will now similarly check to see if it is the destination for that message, read the identity of the virtual source node, “1”, from the virtual source field 40, access the transit part of its routing table 20-7, FIG. 6, in respect of the source/destination pair N1/N9, using the retrieved virtual source node identity, retrieve the pointer value from the field of location #19, “0”, which indicates that Field 0 of location #9, i.e. for destination node N9, is to be accessed to obtain the identity, “8”, of the next hop node to which that Setup Request message 30 is to be forwarded. As before, for convenience, only a portion of the full routing table 20-7 is shown in FIG. 6.

Node N7 now writes the pointer value “0” retrieved from the field of location #19 into the next hop pointer field 62 of its new record 52, and forwards the Setup Request message 30 to node N8.

Upon receipt of that Setup Request message 30 (S/D/VS=1/9/1 ), node NS will perform the same steps, i.e. check its received messages store, create a new record 52 and similarly forward the message to the destination node N9.

Assuming now that the link L7,8 is unavailable. The link L7,8 may be congested; or there may be a fault, either at the node N8 or in the link L7,8, and node N7 ascertains by known means, e.g. alarm messages, failure messages or a timeout, that the attempt to forward the Setup Request message 30 to node N8 has failed. Node N7 now retrieves the pointer value “0” from the next hop pointer field 62 of the new record 52 corresponding to that Setup Request message 30, and inverts its logical value, in this case changes “0” to “1”, and in accordance with that inverted value retrieves the content of Field 1 of the location #9, in this case “10”, which indicates that node N10 is the next hop node to which that Setup Request message 30 is to be forwarded. Node N7 modifies that Setup Request message 30 by replacing, i.e. overwriting, the current, i.e. in this case, initial, content, “1”, of the virtual source field 40 with its own node identity, “7”, and sends the modified Setup Request message 30 to node 10. Node N7 also sets the crankback flag field 58 of the corresponding record 52, i.e. changes “0” to “1”.

The nodes of network 100 are arranged to apply limited loop prevention, as described above. However, if the nodes were not so arranged, the node N7 might receive back from the node N8 a message that it has just sent, i.e. the route involves a “u-turn”, and the node N7 would respond to receipt of this message in the same way as if the link L7,8 had been blocked or otherwise unavailable because of a fault in the link L7,8 or at the node N8.

It will be appreciated that if the original value of location #19 of the routing table 20-7 had been “1”, indicating that the transit mode route to the destination node N9 was the source mode secondary route via node N10, i.e. that the primary route from node N7 to node N9 is not part of the primary route from node N1 to node N9, and that either node N10 or the link L7,10 was faulty, then when node N7 overwrites the virtual source field 40 with its own node identity and switches to source mode operation, it will invert the pointer value “1” retrieved from the next hop node field 62 of the corresponding record 52 to a new pointer value, “0”, and use the source mode primary next hop node N8.

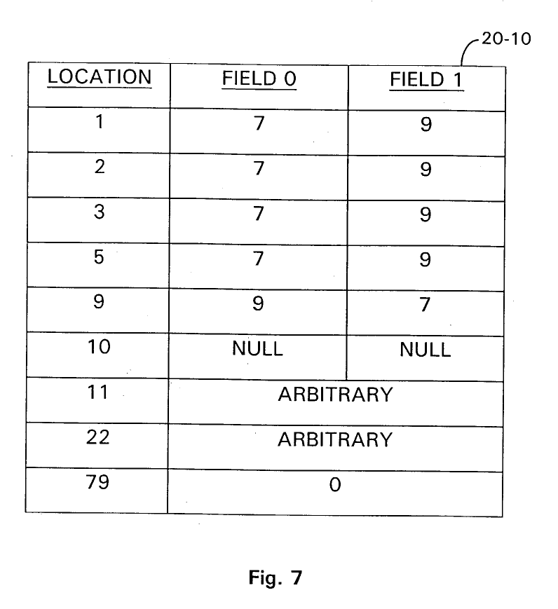

Upon receipt of the modified Setup Request message 30 (S/D/VS=1/9/7), node N10 checks its received messages store, creates a new record 52 in its received messages store (50-10, but not shown separately), checks whether it is the destination node for that message, which it is not, and then in accordance with retrieved virtual source and destination node identities, “7” and “9”, respectively, accesses the field of location #79 of its routing table 20-10, FIG. 7, retrieves the pointer value, “0”, stores the pointer value “0” in the next hop pointer field 62 of that new record 52, retrieves the content of Field 0 of location #9, “9”, and forwards the message to the destination node N9.

If, however, there is, say, a fault on the link L9,10 and the Setup Request message 30 cannot be forwarded, then node N10 inverts the pointer value retrieved from the next hop pointer field 62 of the corresponding record 52 to give a new pointer value of “1”, sets the crankback flag in field 58 of that corresponding record 52, changes the virtual source node identity in field 40 from “7” to “10” and attempts to send the Setup Request message 30 to the destination node N9 via the secondary route in Field 1 of location #9, namely “7”. However, the use of this secondary route from node N10 to node N9 via next hop node N7 will not be allowed by LLP, and node N10 will check the state of the crankback flag in field 58 of that corresponding record 52, and because it is now in its set state, it will retrieve the content, “7”, of the previous hop node identity field 56 of that corresponding record 52, change the virtual source node identity in field 40 of the Setup Request message 30 to “7”, and will send the modified Setup Request message 30 back to the previous hop node N7.

Upon receipt of the modified Setup Request message 30 at node N7, node N7 will first check its received messages store to see whether it had received that message before, find that it had, and also that the crankback flag for the corresponding record 52 is now in its set state. Thus node N7 will now know that it has failed to find a route to the destination node N9 on both its primary and its secondary routes. Node N7 now proceeds to overwrite the current contents, “7”, of the virtual source field 40 with the identity of the preceding node N3, “3”, (obtained from the previous hop node identity field 56 of the corresponding record 52) and to send the modified Setup Request message 30 back to the preceding node N3.

Node N3 will respond to receipt of this modified Setup Request message 30 (now S/D/VS=1/9/3) by similarly first checking its received messages store to see whether it had received that message before, and find that there is a corresponding record 52, i.e. one having a message ID matching that of this received modified Setup Request message 30. However, node N3 will find that the crankback flag of the field 58 of that record is still in its reset state. Node N3 will also retrieve the current contents of the virtual source field 40, which it will match with its own node identity and proceed on the basis that it is the source of that message.

Node N3 has not stored the Setup Request message 30, and needs to know which next hop node to use next. In this specific embodiment, the node N3 accesses the corresponding record 52, retrieves the pointer value from its next hop pointer field 62, in this case “1”, inverts this retrieved pointer value to the value “0”, and accesses the Field 0 of location #9 to retrieve the next hop node identity 6. The node N3 then sends the modified Setup Request message 30 (S/D/VS=1/9/3) to next hop node N6.

In one variant, the records 52 do not include a next hop pointer field 62, but when a node receives a cranked back message and needs to try forwarding it on the other of the pair of routes to the destination node, it repeats the process of retrieving the pointer value from the location corresponding to the S/D combination, and then inverts the retrieved pointer value.

In another variant, the records 52 again do not include a next hop pointer field 62, but when a node receives a cranked back message and needs to try forwarding it on the other of the pair of routes to the destination node, it uses the identity of the node from which it has just received that cranked back message to eliminate the next hop node of the Fields 0 and 1 which corresponds to that node. For the network topography of this specific embodiment, Fields 0 and 1 contain the next hop node identities 6 and 7, respectively, and therefore the next hop node 7 is eliminated, and node N3 sends the modified Setup Request message 30 (S/D/VS=1/9/3) to next hop node N6.

Upon receipt of the forwarded Setup Request message 30 from node N3, node N6 will deem the message as coming from source node N3, and acting in transit mode, access location #39 of its routing table (20-6, but not shown separately), retrieve the pointer value of its field, “0”, and access Field 0 of location #9 of its routing table and retrieve the content of its Field 0, “9”, and attempt to route the message to destination node N9.

FIG. 8 shows a practical form of the second part of the routing tables 20-X in which the entries stored in an n by n matrix 70-X, for example the matrix 70-3 shown in FIG. 8, in which the individual cells hold a single data bit. As shown in FIG. 8, the rows of the matrix 70-3 are accessed by virtual source node identity and the columns of the matrix 70-3 are accessed by destination node identity. Thus, there are arbitrary entries for all source/destination pairs “ii” because they will not exist, and furthermore there are arbitrary entries in all the cells of column j of matrix 70-j because if a node is the destination for a received message, then it will not be required to act in transit mode. It will be appreciated that for convenience not all the operational cells of the matrix 70-3, i.e. cells other than those whose content is arbitrary, have their content indicated in FIG. 8.

In these variants, when the node N3 processes the Setup Request message 30 received from node N1, having ascertained that it is not the destination node and not the source node, it will access its matrix 70-3 in accordance with virtual source node identity “1” and destination node identity “9” and retrieve the content of cell 1,9, “0”, and then access Field 0 of location #9 of the first part of its routing table 20-3.

To sum up, each node has a routing table with three columns, one for the identity of the virtual source node, one for the identity of the destination node, and one for the identity of the next node in the route to that destination node. For traffic originating at a node there are always for each destination node two next hop node entries, the primary and secondary routes, but for transit traffic there is only a single entry for each destination node, this being one or other of the primary and secondary routes, and being usually, but not always, the primary route from that node to the destination node.

The above described method has following advantages:

(i) as compared with conventional routing tables in which each node stores a complete set of source/destination node pair identities and for each such pair the identities of the corresponding primary and secondary next hop nodes, there is considerable reduction in size of routing table, for example for a network of 100 nodes and a node identity size of 64 bits the conventional routing table routing table size would be 100*99*64*2=1,267,200 bits, whereas with the routing table of the alternative embodiment the size would be 20,000+(64*198)=32,672 bits, which represents a reduction factor of nearly 40.

(ii) it allows loop free routes to be specified for sparsely connected networks under single element, i.e. node or link, failure conditions with only a limited loop prevention mechanism in operation.

(iii) it minimises the operation of crankback under single element failure conditions.

(iv) it can operate successfully with either “crankback to source” or “hop by hop crankback” under failure conditions.

(v) if used with “hop by hop crankback” it will lead to shorter alternative routes than source routing, but will provide the same resilience advantages as source routing.

(vi) it could be used to implement load balancing.

(vii) provided that the source routes are node disjoint, for each source-destination combination, only one routing table entry may be needed at every switch except for the source switches, which always require a set of two.

Unless the context clearly requires otherwise, throughout the description and the claims, the words “comprise”, “comprising” and the like are to be construed in an inclusive as opposed to an exclusive or exhaustive sense; that is to say, in the sense of “including, but not limited to”.

1. A method of routing a message in a communications network of interconnected nodes, the nodes being arranged to generate messages, each message having a destination information element containing the identity of a destination node for that message, a source information element containing the identity of the source node of that message, and a virtual source information element initially containing the identity of that source node, and each of the nodes having a respective routing table containing respective entries corresponding to source node/destination node pairs, each entry being in the form of a ranked pair of alternative next hop routes, the method comprising performing at a said node the steps of:
(a) comparing its own node identity with the destination node identity of a message to be routed; and, when it is not the destination node for that message,
(b) comparing its own node identity with the virtual source node identity of that message, and,
if there is a match at step (b),
(c) operating in source mode, else,
(d) operating in transit mode;
wherein step (c) comprises the substeps of
(e) accessing its routing table in accordance with the virtual source node/destination node pair of that message to find the corresponding entry,
(f) forwarding the message to the higher ranking next hop route of that corresponding entry if that higher ranking next hop route has not been tried for that message, and in the event that that higher ranking next hop route is unavailable or has already been tried for that message,
(g) forwarding the message to the next hop route of that corresponding entry not yet tried, and in the event that step (g) fails,
(h) replacing the content of the virtual source information element of the message with the node identity of the node from which that message was received, and
(i) sending that message back to that node from which it was received;
and wherein step (d) comprises the substeps of
(j) retrieving, in accordance with the virtual source node/destination node pair of that message, a pointer from a matrix of pointers forming part of that routing table,
(k) selecting one of the ranked pair of alternative next hop routes of that corresponding entry in accordance with that retrieved pointer,
(l) forwarding the message to the selected next hop route, and in the event that step (l) fails,
(m) replacing the content of the virtual source information element of the message with its own node identity and performing step (c) from substep (g) onwards.

2. A method as claimed in claim 1, wherein:
substep (f) comprises the further substep (n) of checking a handled messages store of the said node to see whether the handled messages store already contains an entry for that message and making a new entry for that message in the handled messages store if it does not already contain such an entry, and
substep (l) comprises the further substep (o) of making a new entry for that message in a handled messages store of the said node.

3. A method as claimed in claim 2, wherein
substep (n) comprises the further substep (p) of storing in a next hop identifier field of that new entry made by the substep (n) an identifier for that higher ranking next hop route for that message, and
substep (o) comprises the further substep (q) of storing in a next hop identifier field of that new entry made by the substep (o) the pointer retrieved from the matrix.

4. A method as claimed in claim 3, wherein, when substep (n) finds that the handled messages store already contains an entry for that message, substep (g) comprises the further substep (r) of using the content of the next hop identifier field of the entry for that message for selecting the said as yet untried next hop route for that message.

5. A method as claimed in claim 4, wherein the said pointers are single bit pointers.

6. A method as claimed in claim 5, wherein, when substep (g) is performed subsequently to substep (m), step (g) comprises the further substep (s) of accessing the stored retrieved pointer of the entry for that message and using bit inversion for selecting the said as yet untried next hop route for that message.

7. A method as claimed in any one of claims 4 to 6, wherein step (g) comprises the further substep (t) of setting a crankback flag of the entry for that message in the handled messages store when forwarding the message, and wherein step (g) fails when an entry found by substep (n) contains a crankback flag in its set state.

8. A node for use in a communications network of interconnected nodes, the node being arranged to generate messages, each message having a destination information element containing the identity of a destination node for that message, a source information element containing the identity of the source node of that message, and a virtual source information element initially containing the identity of that source node, and having a routing table for containing respective entries corresponding to source node/destination node pairs of the network, each entry being in the form of a ranked pair of alternative next hop routes, and being arranged:
to compare its own node identity with the destination node identity of a message to be routed; and, when it is not the destination node for that message,
to compare its own node identity with the virtual source node identity of that message, and,
to operate in source mode in the event of a match between its own node identity and the virtual source node identity by
accessing its routing table in accordance with the virtual source node/destination node pair of that message to find the corresponding entry,
forwarding the message to the higher ranking next hop route of that corresponding entry if that higher ranking next hop route has not been tried for that message, and in the event that that higher ranking next hop route is unavailable or has already been tried for that message,
forwarding the message to the next hop route of that corresponding entry not yet tried, and in the event that the not yet tried next hop route is not available,
replacing the content of the virtual source information element of the message with the node identity of the node from which that message was received, and
sending that message back to that node from which it was received; and
to operate in transit mode in the event of a mismatch between its own node identity and the virtual source node identity by
retrieving, in accordance with the virtual source node/destination node pair of that message, a pointer from a matrix of pointers forming part of that routing table,
selecting one of the ranked pair of alternative next hop routes of that corresponding entry in accordance with that retrieved pointer,
forwarding the message to the selected next hop route, and in the event that the selected next hop route is not available,
replacing the content of the virtual source information element of the message with its own node identity and switching to operate in source mode by
forwarding the message to the next hop route of that corresponding entry not yet tried, and in the event that the not yet tried next hop route is not available,
replacing the content of the virtual source information element of the message with the node identity of the node from which that message was received, and
sending that message back to that node from which it was received.

9. A node as claimed in claim 8, and further arranged to check a handled messages store of the said node to see whether the handled messages store already contains an entry for that message and to make a new entry for that message in the handled messages store if it does not already contain such an entry.

10. A node as claimed in claim 9, and further arranged to store in a next hop identifier field of that new entry for that message an identifier for that higher ranking next hop route for that message, if it is operating in source mode and has generated that message, and otherwise, if it is operating in transit mode and has received that message, to store in a next hop identifier field of that new entry the pointer retrieved from the matrix.

11. A node as claimed in claim 10, and further arranged, in the event that the check of the handled messages store finds that the handled messages store already contains an entry for that message, to use the content of the next hop identifier field of the entry for that message for selecting the said as yet untried next hop route for that message.

12. A node as claimed in claim 11, wherein said next hop route identifier and said pointer are both in the form of a single bit.

13. A node as claimed in claim 12, and further arranged, when handling a message for which there is already an entry in the handled messages store, to access the next hop identifier field of that entry and to use bit inversion for selecting the said as yet untried next hop route for that message.

14. A node as claimed in any one of claims 9 to 13, and further arranged, when handling a message for which there is already an entry in the handled messages store, to change the state of a crankback flag of that entry from reset to set when forwarding the message, and, if that crankback flag is already in its set state, to replace the content of the virtual source information element of that message with the node identity of the node from which that message was received, and to send that message back to that node from which it was received.

15. A communications network comprising interconnected nodes as claimed in any one of claims 8 to 14.

16. A method of routing in a communications network, as claimed in claim 1 and substantially as hereinbefore described with reference to the drawings.

17. A node for use in a communications network, as claimed in claim 8 and substantially as hereinbefore described with reference to the drawings.
